(19) United States
(12) Patent Application Publication
(10) Pub. No.: US 2011/0055403 A1
(43) Pub. Date: Mar. 3, 2011

(54) Collaboration agent based system architecture to support collaborative multimedia applications over wireless networks

(76) Inventors: Krishna Balachandran, Morganville, NJ (US); Katherine H. Guo, Scotch Plains, NJ (US); Kiran M. Rege, Marlboro, NJ (US)

(21) Appl. No.: 12/585,027

(22) Filed: Sep. 1, 2009

(51) Int. Cl. G06F 15/16

(52) U.S. Cl. 709/227; 709/247

(57) ABSTRACT

In one embodiment, a method of sending data from a first node participating in a session of a collaborative application via a wireless network to a plurality of second nodes participating in the session of the collaborative application via a wired network includes generating a plurality of data streams corresponding to the plurality of second nodes at the first node, reducing the plurality of data streams to a single stream from among the plurality of data streams, and sending the single data stream to a collaboration agent associated with the first node and connected to the wired network. In another embodiment instances of the collaborative application are run at both the first node and the collaboration agent. In yet another embodiment, an instance of the collaborative application is run only at the collaboration agent which is connected to the first node via a bi-directional windows sharing link.

### BACKGROUND OF THE INVENTION

1. Field

The present invention relates to architectures and protocol methods that enhance the multimedia collaboration experience in wide area networks with significant access bandwidth limitations or high latency (e.g. wide area cellular networks).

2. Description of Related Art

Universal adoption of the Internet Protocol (IP) suite, improved wired access bandwidth availability (e.g. within corporate intranets, broadband access over DSL, coaxial cable or fiber) and the growth of IEEE 802.11x based hotspots have spurred the rapid growth and adoption of several IP-based applications (client-server based applications such as web browsing, file transfer, e-mail, remote desktop/file system access, Virtual Private Network access and peer-to-peer applications such as instant messaging, file sharing, collaborative multimedia, audio/video conferencing etc.). Several of these applications provide a relatively good user experience over wired networks (and WiFi-based hotspot extensions) in terms of key application layer performance indicators such as perceived throughput, delay, loss and jitter.

Multiple problems are encountered when supporting collaborative multimedia applications (e.g. Microsoft's NetMeeting™) over networks where one or more participants access the application via mobile radio links. Due to lack of support for IP multicast in network infrastructure, collaborative applications typically rely on Application Level Multicast (ALM) when sending multiple identical streams to multiple end points. This is, typically, true for applications that are ad hoc or peer-to-peer in nature, i.e., those that do not involve a server in the communication path.

For example, Microsoft NetMeeting is a peer-to-peer collaboration application that allows users to join a session and share windows, desktops, audio and video within the session. Based on the calling pattern followed by the users while joining the session, NetMeeting builds a tree for ALM where either of the first two users in the session serves as the root of the tree. Typically the user in the session receiving calls from later users becomes the parent in the ALM tree for users originating the calls. In the case where all subsequent users place a call to the first user to join a session, the ALM tree becomes a star topology.

NetMeeting is an example of a collaborative application which is extremely popular with enterprise users. Like many of the Microsoft Office products, NetMeeting is designed for the LAN environment when bandwidth is abundant. However, more often than not, enterprise users are physically distributed across the globe, and connected to the corporate intranet through various access networks such as cable modem, DSL, WiFi, and 3G cellular networks. Today's NetMeeting is often used in WAN environments with large delays and through wireless access networks where bandwidth is limited, and delay is large and variable. Since the application-layer broadcast/multicast operations do not take into account the capabilities of the physical links supporting communications, they may, at times, overload the links, leading to poor performance.

This is a particularly serious concern when some of the terminals participating in the collaborative application are connected to the network with wireless links, which, typically, are weaker and lousier than their wired counterparts. As a result, users typically perceive poor quality with collaborative applications like NetMeeting when used in a WAN and/or mobile environment.

### SUMMARY OF THE INVENTION

The present invention relates to architectures and protocol methods that enhance the multimedia collaboration experience for groups including users wirelessly connected to wide area networks.

In one embodiment, a method of sending data from a first node participating in a session of a collaborative application via a wireless access link to a first network to a plurality of second nodes participating in the session of the collaborative application includes generating a plurality of data streams corresponding to the plurality of second nodes at the first node. A compression operation is performed on the plurality of data streams by reducing the plurality of data streams to a single stream from among the plurality of data streams, and the single data stream is sent to a collaboration agent associated with the first node, the collaboration agent being connected to a second network through a link having at least one of higher reliability and higher bandwidth compared to the wireless access link of the first node.

In another embodiment, a method of forwarding data received from a first node participating in a session of a collaborative application via a wireless access link to a first network to a plurality of other nodes participating in the session of the collaborative application includes receiving a single data stream from the first node at a collaboration agent connected to a second network through a link having at least one of higher reliability and higher bandwidth compared to the wireless access link of the first node. A decompression operation is performed on the single data stream by forming copies of the single data stream corresponding to each of the plurality of second nodes. The formed copies of the single data stream are sent to each of the plurality of second nodes.

In another embodiment, a method of handling a first call sent to a first node capable of participating in a session of a collaborative application via a wireless access link to a first network from a second node attempting to join a session of the collaborative application with the first node includes receiving the first call sent from the second node at a collaboration agent associated with the first node. The collaboration agent is connected to a second network through a link having at least one of higher reliability and higher bandwidth compared to the wireless access link of the first node. An instance of the collaborative application running at the second node is connected to an instance of the collaborative application running at the collaboration agent based on the first call. A second call is placed from the collaboration agent to the first node, and the instance of the collaborative application running at the collaboration agent is connected to an instance of the collaborative application running at the first node. The instance of the collaborative application running at the collaboration agent is connected to an instance of the collaborative application running at the first node based on the second call such that the first node, the second node and the collaboration agent are all participating in the session of the collaborative application.

In yet another embodiment, a method of handling a first call sent from a first node attempting to join a session of a collaborative application via a wireless access link to a first network to a second node participating in the session of the collaborative application includes receiving the first call sent from the first node at a collaboration agent associated with the first node. The collaboration agent is connected to a second network through a link having at least one of higher reliability and higher bandwidth compared to the wireless access link of the first node. A second call is placed from the collaboration agent to the second node, and an instance of the collaborative application running at the second node is connected to an instance of the collaborative application running at the collaboration agent based on the second call.

In another embodiment, a method of sending data from a first node participating in a session of a collaborative application via a wireless access link to a first network to a plurality of second nodes participating in the session of the collaborative application includes registering the first node with a collaboration agent. The collaboration agent is connected to a second network through a link having at least one of higher reliability and higher bandwidth compared to the wireless access link of the first node. The collaboration agent is controlled to run an instance of the collaborative application using a collaboration agent control window viewable on a display of the first node. The collaboration control window is connected to a control process running on the collaboration agent via a terminal link. An icon associated with desired data is selected via the display of the first node. The collaboration agent is controlled to send the desired data to the plurality of second nodes using the collaboration control window.

In still another embodiment, a method of forwarding data from a first node participating in a session of a collaborative application via a wireless access link to a first network to a plurality of other nodes participating in the session of the collaborative application includes registering, at a collaboration agent, the first node with the collaboration agent. The collaboration agent is connected to a second network through a link having at least one of higher reliability and higher bandwidth compared to the wireless access link of the first node. An instance of the collaborative application is run at the collaboration agent based on first control signals received from the first node by a control process running on the collaboration agent via a terminal link. Second control signals indicating to send desired data via the terminal link are received at the control process. The desired data is sent from the collaboration agent to the plurality of second nodes based on the second control signals.

### BRIEF DESCRIPTION OF THE DRAWINGS

Example embodiments of the present invention will become more fully understood from the detailed description provided below and the accompanying drawings, wherein like elements are represented by like reference numerals, which are given by way of illustration only and thus are not limiting of the present invention and wherein:

FIG. 1 is a diagram illustrating a first exemplary network system.

FIG. 2 is a diagram illustrating another exemplary network system.

FIG. 3 is a diagram illustrating an operation of a collaboration agent and a collaboration client according to an embodiment.

FIG. 4A is a diagram illustrating a bi-directional windows sharing method according to an embodiment.

FIG. 4B is a diagram illustrating a method of mapping a collaboration agent control window to a virtual collaboration agent control window according to an embodiment.

FIG. 5 is a diagram illustrating a method of sharing data stored on a remote node with a mobile node using a collaboration agent according to an embodiment.

FIG. 6 is a diagram illustrating a method of sharing data stored on a mobile node with a remote node using a collaboration agent according to an embodiment.

FIG. 7 is a diagram illustrating method of sharing data stored on a network drive with a remote node using a collaboration agent.

FIG. 8A is a diagram illustrating yet another exemplary network system.

FIG. 8B is a diagram illustrating still another exemplary network system.

### DETAILED DESCRIPTION

Various example embodiments of the present invention will now be described more fully with reference to the accompanying drawings in which some example embodiments of the invention are shown.

Detailed illustrative embodiments of the present invention are disclosed herein. However, specific structural and functional details disclosed herein are merely representative for purposes of describing example embodiments of the present invention. This invention may, however, be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein, the term access terminal (AT) may be considered synonymous to, and may hereafter be occasionally referred to, as a terminal, mobile unit, mobile station, mobile user, user equipment (UE), subscriber, user, remote station, access terminal, receiver, etc., and may describe a remote user of wireless resources in a wireless communication network. The term base station may be considered synonymous to and/or referred to as a base transceiver station (BTS), NodeB, extended Node B, femto cell, access point, etc. and may describe equipment that provides the radio baseband functions for data and/or voice connectivity between a network and one or more users.

Exemplary embodiments are discussed herein as being implemented in a suitable computing environment. Although not required, exemplary embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular abstract data types. The program modules and functional processes discussed herein may be implemented using existing hardware in existing communication networks. For example, program modules and functional processes discussed herein may be implemented using existing hardware at existing network elements or control nodes. Such existing hardware may include one or more digital signal processors (DSPs), application-specific-integrated-circuits, field programmable gate arrays (FPGAs), computers or the like.

In the following description, illustrative embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a mariner well understood by those skilled in the art.

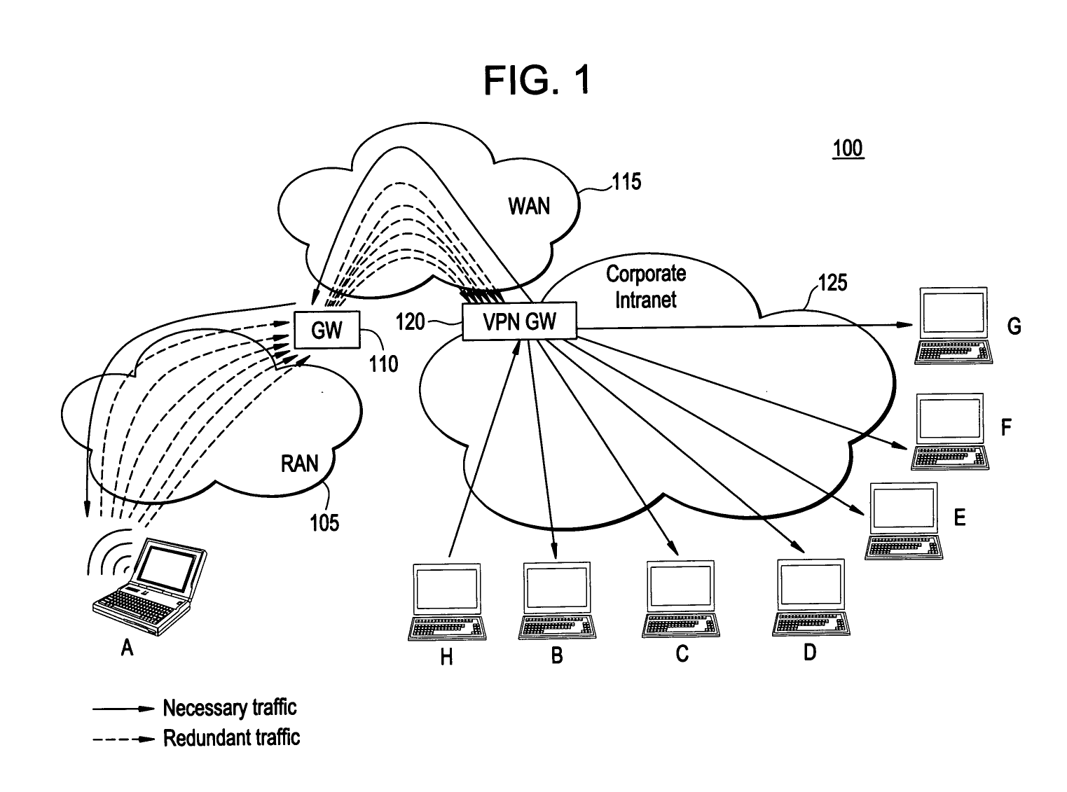

FIG. 1 illustrates a portion of a network 100. Network 100 includes a radio access network (RAN) 105, a wide area network (WAN) 115, and a corporate intranet 125. Radio access network may include, for example, one or more radio network controllers (RNC) each connected to a plurality of base stations (not shown). Radio access network 105 is connected to wide area network 115 via gateway (GW) 110. Wide area network 115 is connected to corporate intranet 125 via virtual private network gateway (VPN GW) 120. Network 100 also includes nodes A-H. Each of nodes A-H is a user device, for example a laptop, or a desktop computer. Each of nodes A-H may include memory for storing programs and processors for executing programs. Node A is a mobile node connected to the RAN 105 via a wireless access link such as a mobile broadband connection provided by, for example, a cellular network service. Each of nodes B-H is assumed to be connected to corporate intranet 125 via a link providing substantially higher and more predictable bandwidth than the wireless access link of the node A, for example a wired connection or a wireless ethernet connection.

Nodes A-H are each communicating with one another through a session of a collaborative, peer-to-peer application such as, for example, NetMeeting. Nodes A-H are using application layer multicast (ALM). Accordingly, nodes A-H communicate with one another using a logical tree structure that is built based on the manner in which each of nodes A-H joins the session of the collaborative application. One typical manner by which a user device may join a session of a collaborative application is calling another user device currently participating in the session of the collaborative application. One user device can call a participating user device by, for example, looking up the IP address of the participating user device in a directory. The calling user device will then be connected to the session of the collaborative application through the called user device.

In FIG. 1, it is assumed that nodes B-G have each connected to the session of the collaborative application by calling node A, and node A has connected to the session of the collaborative application by calling node H.

FIG. 1 illustrates the process of sending data associated with the collaborative application from node H to nodes A-G. Referring to FIG. 1, data is sent from node H to the WAN 115 via the VPN GW 120. The data is then sent from the WAN 115 to the RAN 105 via the GW 110 and received by node A. Because nodes B-G are each connected to the session of the collaborative application through node A, node A must send the data from node H to each of nodes B-G. Accordingly, node A sends six copies of the data from node H from the RAN 105 to the WAN 115 via the GW 110, and then from the WAN 115 to the corporate intranet 125, via the VPN GW 120, where the data sent from node H is received by each of nodes B-G.

Because node A is a mobile node, node A is subject to an increased risk of variations in link quality and complete link loss compared to nodes B-G which have more reliable, higher bandwidth connections to corporate intranet 125. Accordingly, the overall collaborative application experience perceived at nodes B-H may be degraded due to the bottleneck formed at node A. Further, due to the structure of network 100, node A is required to send the same data from node H in the form of six separate transmissions to nodes B-G. This results in six redundant transmissions, represented by the dotted lines illustrated in FIG. 1, which create extra traffic on both the RAN 105 and the WAN 115.

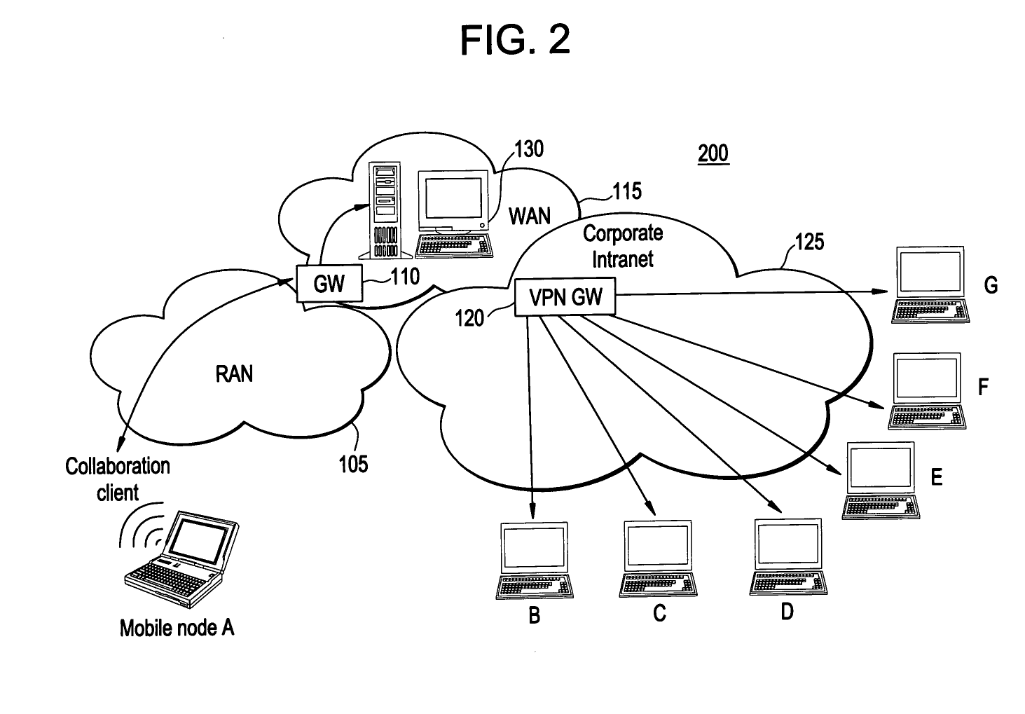

Methods for facilitating the execution of collaborative applications using a collaboration client and a collaboration agent will now be explained with reference to FIG. 2. FIG. 2 illustrates a portion of a data network 200. Network 200 includes a RAN 105, a WAN 115, a corporate intranet 125, a GW 110, and a VPN GW 120 which may each be connected in the same manner discussed above with reference to FIG. 1. Network 200 includes node A, which is connected to the RAN 105 in the same manner described above with reference to FIG. 1, and nodes B-G which are connected to the corporate network 125 in the same manner discussed above with reference to FIG. 1.

In network 200, node A includes a collaboration client. The collaboration client may be embodied as a program stored in memory included in the node A and executed by a processor included in the node A. The collaboration client is capable of intercepting data associated with the session of the collaborative application sent from node A to any or all of nodes B-G. The collaboration client will be discussed in greater detail below.

Network 200 also includes a collaboration agent 130 inside the WAN 115. The collaboration agent 130 is connected to the WAN 115 via a link providing substantially higher and more predictable bandwidth than the wireless access link of the node A, such as a wired connection or a wireless ethernet connection. The collaboration agent 130 communicates with the collaboration client running on the mobile node A and participates in the session of collaborative application on behalf of the mobile node A so that all of the data-heavy communications (e.g. broadcast/multicast media data) remain confined to the wired network, WAN 130, where bandwidth is generally plentiful and links exhibit low packet loss rates in comparison with the wireless network, RAN 105.

The collaboration agent 130 may be embodied as, for example, a program stored on and executed by a desktop computer or a server with a wired connection to the WAN 115. For the purpose of simplicity, collaboration agent 130 will be referred to as a computer running the program rather than the program itself. However it will be understood that multiple collaboration agents can be run on, for example, a single desktop computer or server. The collaboration agent 130 is connected with the collaboration client running on the node A via a link through the RAN 105 and GW 110. Though, for the purpose of simplicity, network 200 is illustrated as having only one mobile node A and one collaboration agent 130, network 200 may have any number of mobile nodes. A plurality of mobile nodes included in network 200 may each have a collaboration client running thereon. Further, for each collaboration client, network 200 may include a corresponding collaboration agent connected to the collaboration client. Specifically, there may be a one-to-one correspondence between collaboration clients and collaboration agents in network 200.

Additionally, it is desirable that each collaboration agent in network 200 have much higher bandwidth access and lower latency when in communication with other nodes compared to the associated mobile node. It is also desirable that each collaboration agent in network 200 have higher or similar computing capability compared to each associated mobile node. Each collaboration agent in network 200 has access to data stored on each corresponding mobile device as well as data stored on network drives that may be accessible via network 200. Each collaboration agent in network 200 also has access to data from sensors on each corresponding mobile device including, for example webcams, microphones and GPS receivers. The collaboration agents access the sensor data via the device drivers associated with each sensor on the corresponding mobile devices.

The operation of the collaboration client and the collaboration agent 130 will now be discussed with reference to three different embodiments. Each of the three embodiments will be discussed in terms of the operation of network 200 illustrated in FIG. 2 with reference to the collaboration client running on node A and the collaboration agent 130. In network 200, nodes A-G are each communicating with one another through a session of a collaborative, peer-to-peer application such as, for example, NetMeeting. Nodes A-G are using application layer multicast (ALM). In network 200, it is assumed that nodes B-G have each connected to the session of the collaborative application through node A.

### First Embodiment

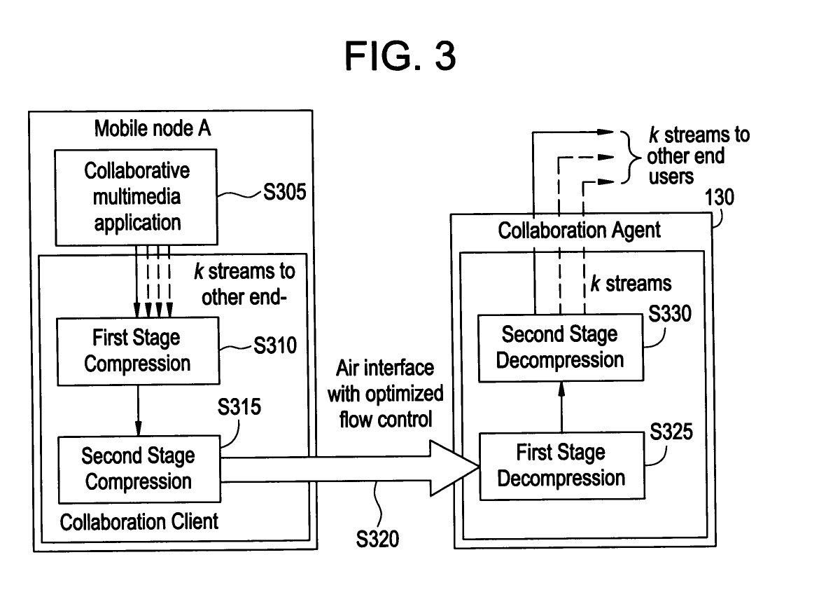

FIG. 3 is a diagram illustrating the operation of the collaboration client running on node A and the collaboration agent 130 according to a first embodiment. In the first embodiment, the collaborative application runs only on the mobile node A, and not on the collaboration agent 130. In step S305, the collaborative application running on node A sends multicast data to nodes B-G. The collaboration application generates k identical data streams where k is a non-zero positive integer equal to the number of nodes with which node A is directly connected in the application-layer multicast tree. With respect to the example illustrated in FIG. 2, node A generates data streams for each of nodes B-H, so k=6. Rather than being sent directly through the RAN 105 in the direction of nodes B-G, the k streams generated by the collaborative application are intercepted by the collaboration client.

In step S310, the collaboration client performs first stage compression on the k data streams. First stage compression is accomplished by reducing the k identical data streams to a single one of the identical data streams. When the collaboration client replaces the k identical data streams with the single stream, the collaboration client augments the latter by including in the corresponding data packets information regarding the k destinations where the contents of that stream need to be delivered. For example, one method of including of the information regarding the k destinations in the single stream is to attach a special header to the packets constituting the single stream sent by the collaboration client to the collaboration agent. The special header includes all the information, including the addresses of the k destinations, that is needed to reconstruct the k original streams.

In step S315, the collaboration client performs second stage compression on the single data stream. Second stage compression may include any of a variety of well known, text, image and/or video compression techniques. Additionally, the second stage compression may incorporate adaptive compression techniques (e.g. adaptive transcoding) that compress the contents of the data stream in accordance with the bandwidth available to the mobile node A for uplink transmissions. Thus, for example, if substantial uplink bandwidth is available (because of favorable channel conditions), the second stage compression would use a higher encoding rate while compressing the data stream. Conversely, during times of low bandwidth availability, a lower encoding rate would be used for data compression.

In step 320, after performing the second stage compression on the single data stream, the single data stream is sent to the collaboration agent 130 via a link between node A and the collaboration agent 130 which traverses the wireless access link between node A and the RAN 105.

The data may be sent using well known optimized flow control techniques. For example, node A and the collaboration agent 130 may establish appropriate window sizes at each protocol layer that are designed to account for the latency over the connection between node A and the collaboration agent 130. For example, with an achievable data rate of 500 kb/s and round trip delay of 200 ms, the buffer sizes may be set to be at least 100 kbits.

In step S325, the collaboration agent A performs first stage decompression on the single data stream received from node A. First stage decompression is accomplished by performing any of a number of well known decompression techniques corresponding to the text, image and/or video compression techniques used during the second stage compression in step S315.

In step S330, the collaboration agent 130 performs second stage decompression on the single data stream to reverse the effects of the first stage compression in step S310. In step S330, the single data stream is rebuilt into k identical data streams, and the k data streams are sent to the original recipients, nodes B-H.

Accordingly, by using the collaboration client running on node A to perform the first stage compression in step S310, node A can share data with each of nodes B-H without sending multiple streams. This eliminates the redundant data streams discussed above with reference to network 100 illustrated in FIG. 1 thus reducing the traffic on both the RAN 105 and the WAN 115 and improving the overall performance of the collaborative application on network 200.

Further, by performing the second stage decompression at the collaboration agent 130 in step S330, the data heavy operation of sending the k streams to nodes B-H is not performed over the less reliable wireless access link between node A and the RAN 115, and is shifted to the faster, more reliable wired networks, WAN 115 and corporate intranet 125. This reduces the severity of the bottle neck formed by mobile node A, due to the relatively lower bandwidth and reliability associated with the wireless link of mobile node A compared to the more reliable, higher bandwidth links of nodes B-H, thus improving the overall performance of the collaborative application on network 200.

When the data being shared originates at a remote node participating in the collaborative application (and is transmitted to the rest of the participants including mobile node A), the following may be done to improve the user experience from mobile node A's perspective: The data stream being sent to mobile node A may be directed to the collaboration agent 130 first so that the collaboration agent 130 can process the data stream via adaptive compression techniques that compress the data stream in accordance with the downlink bandwidth available to mobile node A. When this compressed data stream reaches mobile node A, the mobile node A can decompress the stream before passing it on to the collaborative application. Such an arrangement would ensure that the collaborative application experiences the best quality possible under prevailing conditions or increased quality compared to a case where adaptive compression is not used.

### Second Embodiment

Though the first embodiment discussed above removes the need to send redundant data streams from mobile node A and greatly reduces the amount of data sent over the generally slower, less reliable wireless connection between mobile node A and the RAN 115, the wireless access link between mobile node A and the RAN 115 is still subject to a greater risk of dropping or disconnecting compared to the more reliable, higher bandwidth connections of nodes B-G. If nodes 13-G are connected to a session of a collaborative application through node A, and the wireless connection of node A drops, the connections between each of nodes B-H will be severed and the session of the collaborative application will end for each of nodes B-G.

The second embodiment addresses the issue of severability discussed above. In the second embodiment, the operation of the collaboration client and the collaboration agent 130 is substantially similar to that explained above with reference to FIGS. 2 and 3. However, in the second embodiment, instead of running the collaborative application on only the mobile node A, as in the first embodiment, instances of the collaborative application run on both the mobile node A and the collaboration agent 130. According to the second embodiment, the mobile node A must be registered with the collaboration agent 130. The registration process will be discussed in further detail below. Once the mobile node A is registered, all user devices that wish to connect to a session of the collaborative application through mobile node A will instead be connected to the instance of the collaborative application running on the collaboration device 130. Accordingly, if the mobile node A should lose its wireless access link to the RAN 115, the loss will not affect the connections of any other nodes because no other nodes will be directly connected to the mobile node A. The second embodiment will now be discussed in greater detail below.

### Registration

According to the second embodiment, in order to participate in a session (either as its host or as an ordinary participant) of a collaborative application, the mobile node A must first register with the collaboration agent 130. As is discussed above with reference to FIG. 2, there can be more than one collaboration agent in the network 200. However, for each mobile node in network 200, there is a unique collaboration agent whose IP address is either stored in the terminal or acquired through some standard database access procedure.

The registration process may involve well known authentication/authorization procedures. The collaboration agent 130 has a pool of local IP addresses to assign to mobile terminals. During the registration process, the collaboration agent assigns an IP address from the pool to the mobile node A on a temporary basis, and may also register the mobile node A using this IP address in a directory of the collaborative application. The purpose of assigning the temporary address to the mobile node A is to direct any connections from other users to the collaboration application running on mobile node A to mobile node A's collaboration agent, collaboration agent 130. As a consequence, any other user looking up the address of the mobile node A in the directory will find the temporary address. Mobile node A continues to use its original IP address in all of mobile node A's communications. However other users involved in the session of the collaborative application operate as if the address associated with the mobile node A is the temporary address assigned by the collaboration agent 130.

Handling Calls to and from the Mobile Node A

As is described above in the discussion of FIG. 1, one typical manner in which a user device may join a session of a collaborative application is by calling another user device currently participating in the session of the collaborative application. The calling user device will then be connected to the session of the collaborative application through the called user device. The main difference in the operation of network 200 that results from running the collaborative application on both the mobile node A and the collaboration agent 130 according to the second embodiment is the manner in which calls made by the mobile node A to connect the mobile node A to an existing session of the collaborative application, or received by the mobile node A to connect another node to a session of the collaborative application of which mobile A is a part, are handled.

A method of handling calls intended for the mobile node A from other nodes wishing to join a session of a collaborative application according to the second embodiment will now be discussed. According to the second embodiment, a call intended for mobile node A from another user device, for example node B, is automatically directed to mobile node A's collaboration agent, collaboration agent 130, based on the temporary address assigned to the mobile node A by the collaboration agent 130 during the registration process. This is because node B uses the temporary address assigned to mobile node A when calling the mobile node A. Node B and the collaboration agent 130 are now connected to one another in a session of the collaborative application. Collaboration agent 130 then places a call to mobile node A. Node B and mobile node A are now connected to one another in a session of the collaborative application through the instance of the collaborative application running on the collaboration agent 130. If a third user device, for example node C, places a call to mobile node A, the call is again directed to the collaboration agent 130. Node C and the collaboration agent 130 are now connected to one another in a session of the collaborative application. At this point, there is no need to make another call from collaboration agent 130 to mobile node A because the instance of the collaborative application running at the collaboration agent 130 is already connected to the instance of the collaborative application running at node A. Accordingly, nodes B and C are connected to the collaboration agent 130 which is connected to the mobile node A. Thus, mobile node A can still participate in the session of the collaborative application with nodes B and C, and if the mobile node A loses its wireless connection, nodes B and C will still be connected to the session of the collaborative application through the instance of the collaborative application running on the collaboration agent 130, which has a more reliable, higher bandwidth connection than the wireless access link of the mobile node A.

A method of handling calls placed by the mobile node A to other nodes in order to join a session of a collaborative application according to the second embodiment will now be discussed. If the mobile node A places a call to another node currently participating in a session of a collaborative application, the call is re-directed to the collaboration agent 130, which in turn does one of the following: (a) accepts the call and then places another call to the intended destination node; or (b) rejects the call and then places two calls, one to the mobile node A and the other to the destination node. At the end of this procedure, the mobile end-user is connected to the destination node via the collaboration agent 130.

Accordingly, by using the collaboration agent 130 to stand in the place of the mobile node A, the second embodiment mitigates the increased risk of severability that exists when one or more user devices wish to connect to a session of a collaborative application through a wirelessly connected node such as mobile node A.

### Third Embodiment

In the third embodiment, the collaborative application runs only on the collaboration agent 130, and not on the mobile node A. The mobile node A controls the collaboration agent 130. Because, in the third embodiment, the collaborative application is run only on the collaboration agent 130, which has a more reliable, higher bandwidth connection than that of the wireless access link of the mobile node A (via the WAN 115), in a manner similar to that of the second embodiment discussed above, the third embodiment both removes the need to send redundant streams and addresses the severability issue discussed above with reference to the second embodiment.

As is illustrated in FIG. 2, the mobile node A and the collaboration agent 130 are connected to one another by a link which traverses the RAN 115. According to the third embodiment, the link between the mobile node A and the collaboration agent 130 is a special bi-directional windows-sharing link. The bi-directional windows-sharing link, also referred to hereafter as a terminal link, is used to carry control signals for controlling the action of the collaboration agent 130 as well as bearer traffic associated with display information and media data (e.g. voice/video signals) to enable the mobile node A to view/hear the application being shared among all of the participants.

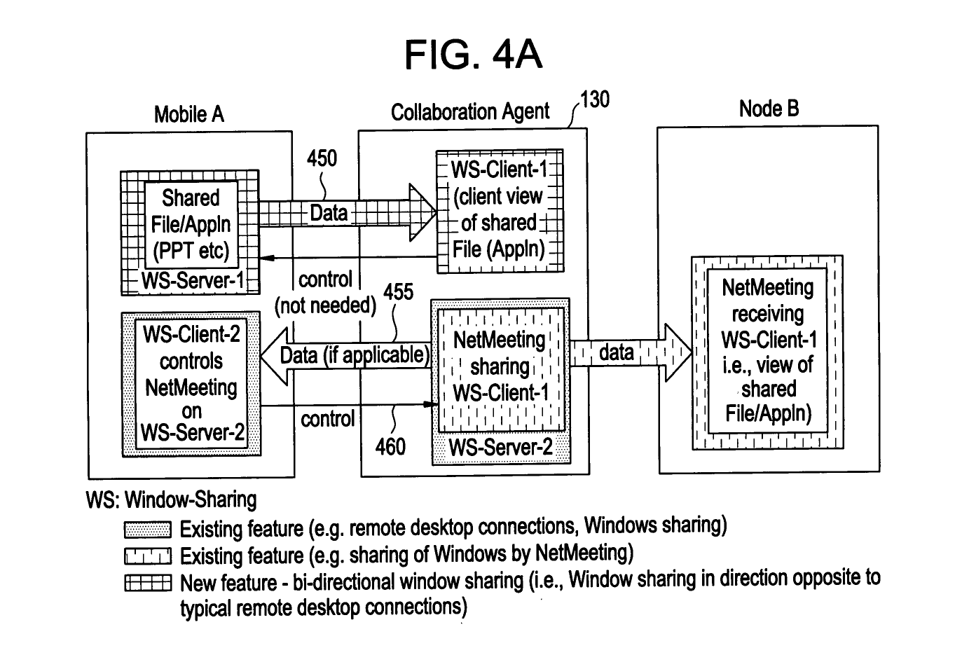

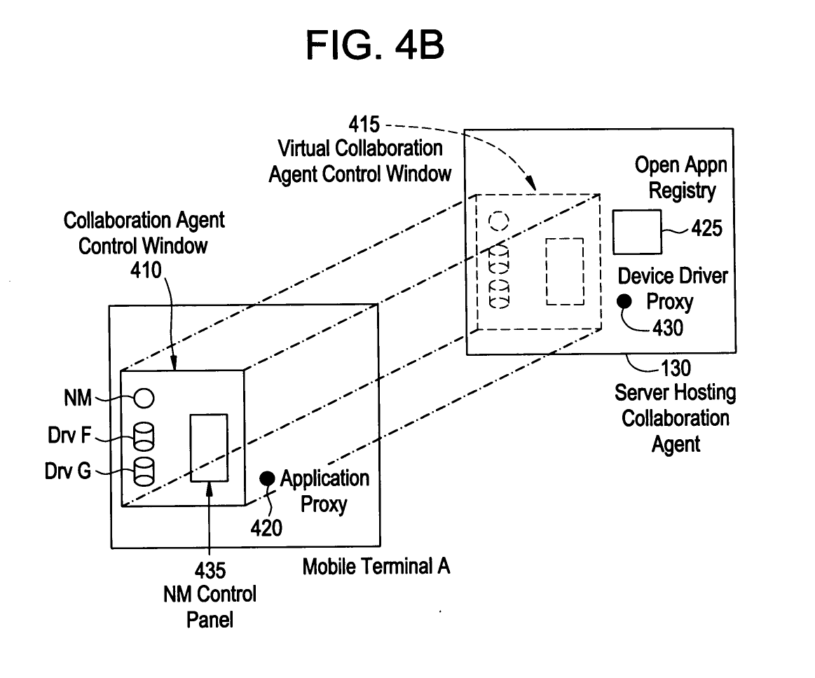

FIG. 4A is a diagram illustrating the concept of the bi-directional window sharing scheme used in the third embodiment. FIG. 4A illustrates the mobile node A, the collaboration agent 130 and the node B. Note that the terminal link carries bearer data from mobile node A to collaboration agent 130 via a first data flow 450 if the data/application being shared resides on the node A. In this case, the mobile node A acts as a first windows sharing server sharing windows, or screens associated with a shared application like Power Point, to the collaboration agent 130, which acts as a first windows sharing client, via data flow 450 for distribution to other participating nodes like node B.

Conversely, if the data/application being shared resides on the collaboration agent 130 or a remote node participating in the collaborative application, for example node B, the terminal link carries bearer data from the collaboration agent 130 to the mobile node A via a second data flow 455. In this case, the collaboration agent 130 acts as a second windows sharing server sharing windows with the mobile node A, which acts as a second windows sharing client, for display at the mobile node A. Further, mobile node A can control the actions of the collaboration agent 130 through control signals 460. First data flow 450, second data flow 455, and control signals 460 are each conveyed via the terminal link between the mobile node A and the collaboration agent 130.

The manner in which the bi-directional windows sharing scheme described above is used to share a collaborative application is described in greater detail below using the application NetMeeting as an example. First, a registration process that takes place between the mobile node A and the collaboration agent 130 will be discussed.

### Registration

As is discussed above with respect to the second embodiment, according to the third embodiment, in order to participate in a NetMeeting session (either as its host or as an ordinary participant), the mobile node A must first register with the collaboration agent 130.

As in the second embodiment, the registration process may involve well known authentication/authorization procedures. The collaboration agent 130 has a pool of local IP addresses to assign to mobile node A. During the registration process, the collaboration agent 130 assigns an IP address from the pool to the mobile node A on a temporary basis, and registers the mobile node A using this IP address in a NetMeeting directory. As is discussed above with respect to the second embodiment, the purpose of assigning the temporary address to the mobile node A is to redirect any connections from other users to the instance of the collaborative application running on the mobile node A to mobile node A's collaboration agent, collaboration agent 130. As a consequence, any other user looking up the NetMeeting directory to learn the IP address of the mobile node A will find the temporary address. Mobile node A continues to use its original IP address in all of mobile node A's communications. However other users involved in the NetMeeting session operate as if the address associated with the mobile node A is the temporary address assigned by the collaboration agent 130.

Further, during the registration process, the mobile node A conveys to the collaboration agent 130 all the information necessary to enable the latter to know the entire file structure of the mobile node A, including mobile node A's local and network drives and the applications to which the mobile node A has access. The mobile node A also passes its file-access privileges to the collaboration agent so that the latter can access the user's files on his behalf.

According to the third embodiment, once registration is complete, a collaboration control window, through which the collaboration agent 130 may be controlled by a user of the mobile node A, appears on a screen of the mobile node A. The collaboration control window will be discussed in greater detail below.

### Collaboration Control Window

FIG. 4B is a diagram illustrating a method of mapping a collaboration agent control window 410 on the mobile node A to a virtual collaboration agent control window 415 on the collaboration agent. In this embodiment of the invention, at the end of the registration procedure, collaboration agent control window 410 appears on the mobile terminal A's screen. The collaboration control window 410 is the means by which a user of the mobile terminal A controls the operation of the collaboration agent 130.

The collaboration agent control window 410 contains icons corresponding to all the collaborative applications supported by the collaboration agent 130 as well as the disk drives on the collaboration agent 130 that are accessible to the mobile user. In the example illustrated in FIG. 4B, the collaboration agent control window 410 includes an icon NM corresponding to a NetMeeting application present on the collaboration agent 130. Further, the collaboration agent control window 410 includes icons Dry F and Dry G corresponding network disk drives F and G accessible by the collaboration agent 130.

The collaboration agent control window 410 is associated with a collaboration agent control process running on the mobile terminal A. The collaboration agent control window 410 is mapped to a virtual collaboration control window 415 on the collaboration agent 130. The term “virtual window” is intended to convey the fact that the collaboration agent 130 may not actually display the window to which mobile terminal A's collaboration agent control window is mapped. However, it will be understood that the virtual collaboration control agent window 415 is associated with an actual process running on the collaboration agent 130, referred to as the virtual collaboration agent control process, and could be displayed on the screen of the collaboration agent 130 if required.

The mapping between the collaboration agent control window 410 on the mobile terminal A and the virtual collaboration agent control window/process 415 on the collaboration agent 130 is made via a “remote desktop” like logical connection through the terminal link to enable a user of the mobile terminal A to control the virtual collaboration agent control process on the collaboration agent 130 by pointing at and clicking on icons within the collaboration agent control window 410 on the mobile terminal A's screen. Note that these icons represent applications and/or drives accessible by the collaboration agent 130.

At least one way in which the connection between the collaboration agent control window 410 and the virtual collaboration agent control window 415 differs from the well known remote desktop type connection is that while a remote desktop connection maps all of the current view of a computer's desktop to a window on a remote computer, in the present case, only the screen-views associated with the virtual window control process and the processes it spawns are mapped to corresponding windows on the mobile terminal.

According to the third embodiment, the collaboration agent 130 also includes an open application registry 425 and a device driver proxy process 430, and the mobile node A also includes an application proxy process 420. The application registry 425, device driver proxy process 430, and application proxy process 420 may be created during the registration process described above. The open application registry 425 keeps track of which applications are currently open at either the mobile node A or the collaboration agent 130. The operation of the device driver proxy process 430 and the application proxy process 420 will be discussed further below.

### Joining a Session of a Collaborative Application

The process of joining a session of a collaborative application will now be discussed with reference to the mobile node A joining a NetMeeting session through the collaboration agent 130.

In order for the mobile node A to participate in a NetMeeting session (either as a host or as an ordinary participant), the user of the mobile node A clicks on the NetMeeting icon NM in the collaboration agent control window 410. The remote-desktop-like connection between the mobile terminal and the collaboration agent conveys the user actions within the collaboration agent control window 410 (e.g. clicking on the NetMeeting icon) to the collaboration agent 130 so that a NetMeeting control process representing the mobile node A is spawned on the collaboration agent 130.

In accordance with this embodiment, the screen-view associated with the NetMeeting control panel 435 is sent to the device driver proxy 430 on the collaboration agent. The device driver proxy 430 encodes and packetizes the data associated with the screen-view and transmits the data to the application proxy 420 on the mobile terminal. The application proxy 420 extracts the screen-view from the packets received from the device driver proxy and displays it on the mobile terminal's screen via the appropriate device driver. Thus, the NetMeeting control panel 435 appears on the mobile node A's screen instead of the collaboration agent 130's screen. The NetMeeting control panel 435 in collaboration agent control window 410 may be used by a user of the mobile node A to control the NetMeeting control process running on the collaboration agent 130.

Accordingly, the method of mapping the collaboration agent control window 410 to the virtual collaboration agent control window 415 illustrated in FIG. 4B allows a user of the mobile node A to control the collaboration agent 130 to participate in a collaborative application like NetMeeting on behalf of the mobile node A. Further, using the remote desktop like connection between the mobile node A and the collaboration agent 130, media or data shared by the actual participants in the collaborative application can be made visible and/or audible at the mobile node A.

Below, three operational scenarios are provided to explain how the third embodiment of the present invention supports collaborative multimedia applications. Each of the scenarios will be explained with reference to the mobile node A and collaboration agent 130 in network 200 illustrated in FIG. 2. In each of the scenarios described below, it is assumed that the mobile node A has already been registered at the collaboration agent 130, and has already controlled the collaboration agent 130 to join a NetMeeting session. Further, it is assumed that nodes B-G are also participating in the NetMeeting session.

### Scenario 1

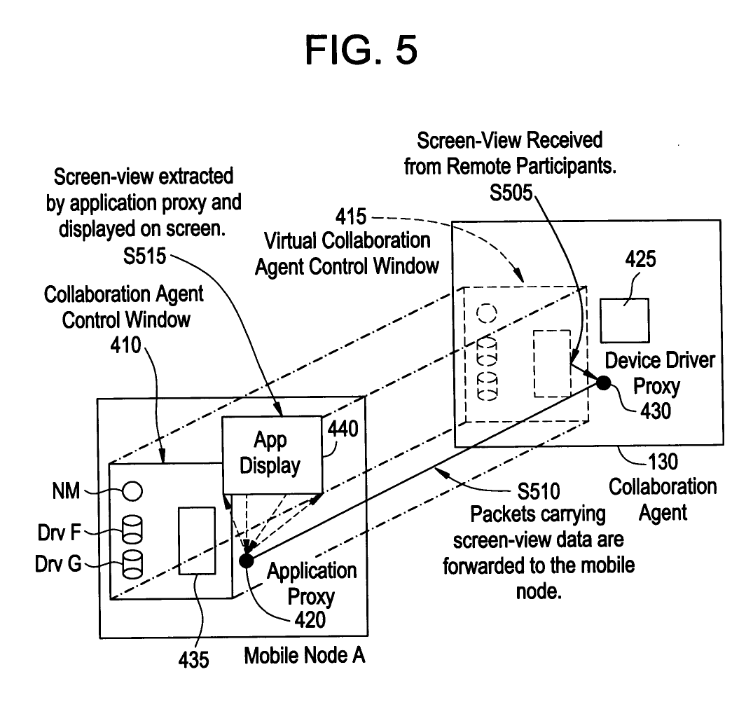

FIG. 5 illustrates a detailed method of handling a scenario in which a remote participant, for example node B, opens up an application (e.g. a Power Point presentation) and shares it with the rest of the participants in the NetMeeting session. The sequence of actions characterizing this scenario will be described below with reference to steps S505˜S515.

In step S505, a screen-view associated with the Power Point presentation is distributed to the rest of the participants, collaboration agent 130, and nodes C-G, by the NetMeeting application residing on each participant.

Since one of participants in the NetMeeting session is the NetMeeting control process on the collaboration agent 130, the NetMeeting control process also receives the screen-view associated with the application being shared. Note that in order to send data to the mobile node A, all of the remote participants use the IP address temporarily assigned to the mobile node A by the collaboration agent 130. With respect to the network 200, this address is associated with the collaboration agent 130 so that the data gets delivered to the collaboration agent 130. However, with respect to the collaboration agent 130, the destination IP address in the packets carrying the screen-view being shared by the remote participant is associated with the NetMeeting control process that was created by the remote actions of the mobile user. As a result, the screen-view data gets passed to the NetMeeting control process.

In step S510, the NetMeeting control process on the collaboration agent 130 sends the screen view to the device driver proxy process 430, which, in turn, encodes and/or packetizes the data representing the screen-view and sends the data to the application proxy process 420 running on the mobile node A.

In step S515, at the mobile terminal, the application proxy process extracts the screen-view from the packets, and sends it to the appropriate device driver for display on the mobile node A's screen.

### Scenario 2

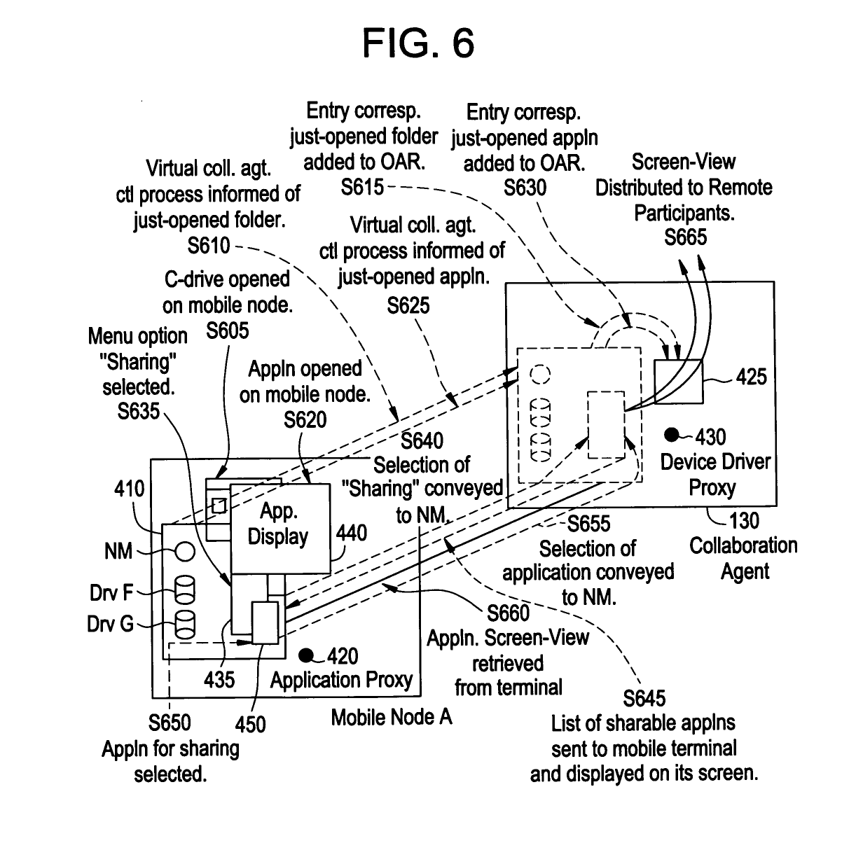

FIG. 6 illustrates a detailed method of handling a scenario in which a user associated with the mobile node A shares an application (e.g. a Power Point presentation) that is stored on a local drive of the mobile node A. It is assumed that the file corresponding to the Power Point presentation is stored in the top-level folder on the mobile terminal's local drive “C.”

Referring to FIG. 6, in step S605 the user of the mobile node A clicks on the icon for the local drive C (not shown) on the mobile terminal's desktop and opens the top-level folder associated with the C drive on the mobile terminal's screen. Since the Power Point file is in the top-level folder associated with drive C, the icon associated with that file is visible to the user on a window on the mobile terminal's screen that has just been opened up.

In step S610, the collaboration agent control process running on the mobile node A informs the virtual collaboration agent control process running on the collaboration agent 130 of the user's action, i.e. that of opening the top-level folder on drive C.

In step S615, the virtual collaboration agent control process updates the open applications registry 425 by including an entry corresponding to the just-opened folder.

In step S620, the user clicks on an icon corresponding to the Power Point presentation, which results in application display 440 being opened up on the mobile node A's screen, displaying the first slide in the presentation.

In step S625, the collaboration agent control process running on the mobile nod A informs the virtual collaboration agent control process running on the collaboration agent 130 that a new application, a Power Point presentation, has been opened.

In step S630, the virtual collaboration agent control process adds an entry corresponding to the Power Point presentation to the open applications registry 425.

In step S635, in order to share the Power Point presentation, the user clicks on a “Tools” tab on the NetMeeting panel 435 in the collaboration agent control window 410 and selects a menu option “Sharing.”

In step S640, due to the remote-desktop-like nature of the mapping between the collaboration agent control window 410 and the virtual collaboration agent control window 415, the user's actions effectively lead to the selection of the menu option “Sharing” associated with the NetMeeting control process running on the collaboration agent 130.

In step S645, as a result of the selection of the “Sharing” option, the NetMeeting control process outputs a window containing a list of sharable applications. However, instead of calling the appropriate device driver to display the window containing the list of sharable applications, the NetMeeting control process sends the corresponding data to the device driver proxy 430 on the collaboration agent 130. It should be noted that the NetMeeting process running on the collaboration agent 130 gets a list of sharable applications from the open applications registry 425.

The device driver proxy 430 then encodes/packetizes the data corresponding to the window containing the list of sharable applications, and sends it to the application proxy 420 on the mobile node A. The application proxy 420 extracts the data corresponding to the window containing the list of sharable applications and sends the extracted data to the appropriate device driver on the mobile node A for displaying the list of shareable applications as shareable application list 450.

In step S650, the user selects the entry from the shareable application list 450 that corresponds to the Power Point presentation.

In step S655, the action of selecting the application for sharing is conveyed to the virtual collaboration agent control process on the collaboration agent 130.

In step S660, Using the terminal link in the direction from the mobile node A to the collaboration agent 130, the virtual collaboration agent control process retrieves the screen-view associated with the Power Point presentation from the mobile node A

In step S665, the virtual collaboration agent control process running on the collaboration agent 130 prompts the NetMeeting control process running on the collaboration agent 130 to distribute the screen-view retrieved in step S655 to the rest of the participants, node B-G.

### Scenario 3

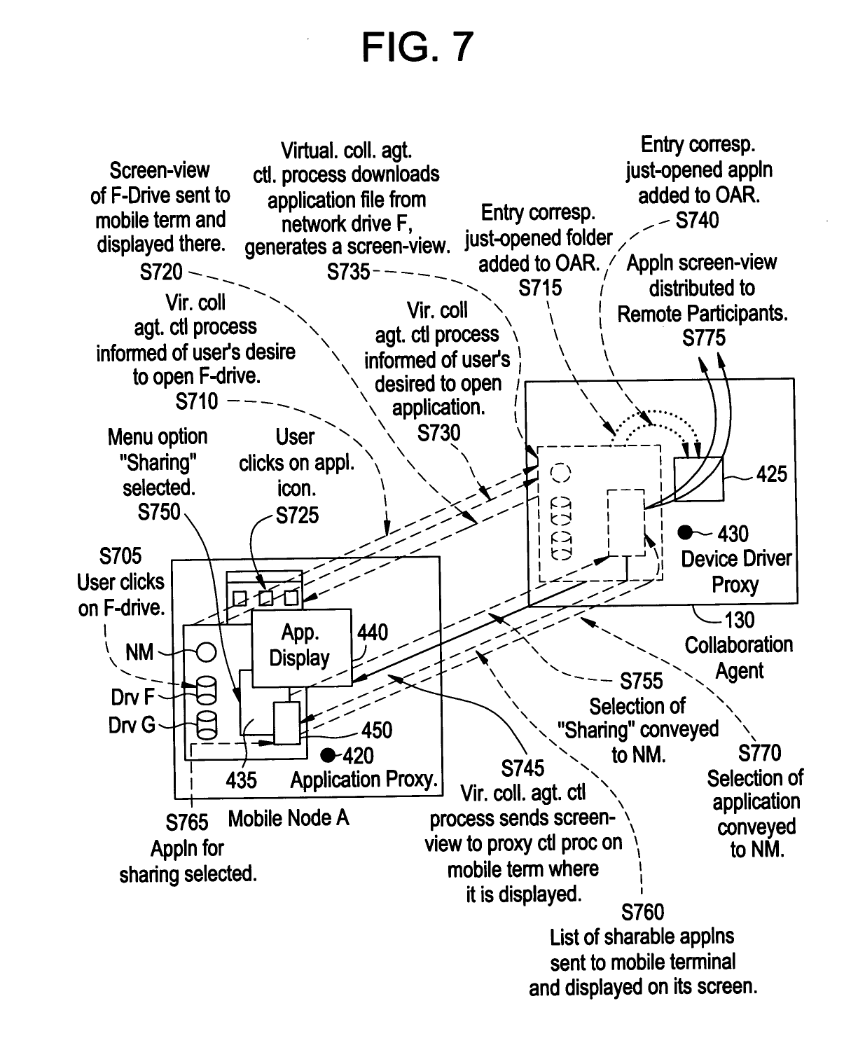

FIG. 7 illustrates a detailed method of handling a scenario in which the user shares an application stored on a network drive, for example drive F included in collaboration agent control window 410.

Referring to FIG. 7, in step S705 the user clicks on the icon corresponding to drive F in the collaboration agent control window 410 on the mobile node A.

In step S710, the action of the user in step S705 is conveyed to the virtual collaboration agent control process running on the collaboration agent 130 via the remote-desktop-like connection between the mobile node A and the collaboration agent 130.

In step S715, the virtual collaboration agent control process opens the top-level folder corresponding to network drive F, and adds a corresponding entry to the open applications registry 425.

In step S720, the screen-view associated with the top-level folder associated with drive F is directed to the device driver proxy 430 on the collaboration agent 130. The device driver proxy encodes/packetizes the corresponding data and sends it to the application proxy 420 on the mobile node A. The application proxy 420 decodes the content of the packets, extracts the screen-view, and displays the screen-view on the screen of the mobile node A.

In step S725, the user clicks on the icon corresponding to the desired application, for example a Power Point presentation, within the screen-view corresponding to the top-level folder associated with drive F displayed on mobile node A's screen.

In step S730, the user's action of clicking on the icon representing the desired application is conveyed to the collaboration agent 130 via the remote-desktop-like connection.

In step S735, the collaboration agent 130 downloads the file corresponding to the Power Point presentation from the network drive and opens it up.

In step S740 an entry corresponding to just-opened Power Point presentation is made into the open applications registry 425.

In step S745, the screen-view associated with a first slide of the Power Point presentation, is sent via the device driver proxy 430 to the application proxy 420 in mobile node A, and is displayed on the mobile node A's screen.

In step S750, the user selects the menu option “Sharing” on NetMeeting panel 435 being shown within the collaboration agent control window 420 on the mobile node A's desktop.

In step S755, the user's selection in step S750 is conveyed to the collaboration agent 130 via the remote-desktop-like connection between the mobile node A and the collaboration agent 130.

In step S760, the NetMeeting process running on the collaboration agent 130 outputs a list of applications that can be shared with remote users, for example node B-G, participating in the NetMeeting session. This application list includes the just-opened Power Point presentation since the corresponding entry has been added to the open applications registry 425. The window showing the list of sharable applications is conveyed to the mobile node A via the device driver proxy—application proxy chain and is displayed on the screen of the mobile terminal A.

In step S765, the user of the mobile node A selects the Power Point application for sharing by clicking on the appropriate buttons.

In step S770, the user's selection in step S765 is conveyed to the collaboration agent via the terminal link.

In step S775, the NetMeeting process sends screen-views associated with the Power Point presentation to the rest of the participants in the NetMeeting session, node B-G.

### Alternative Deployment Models

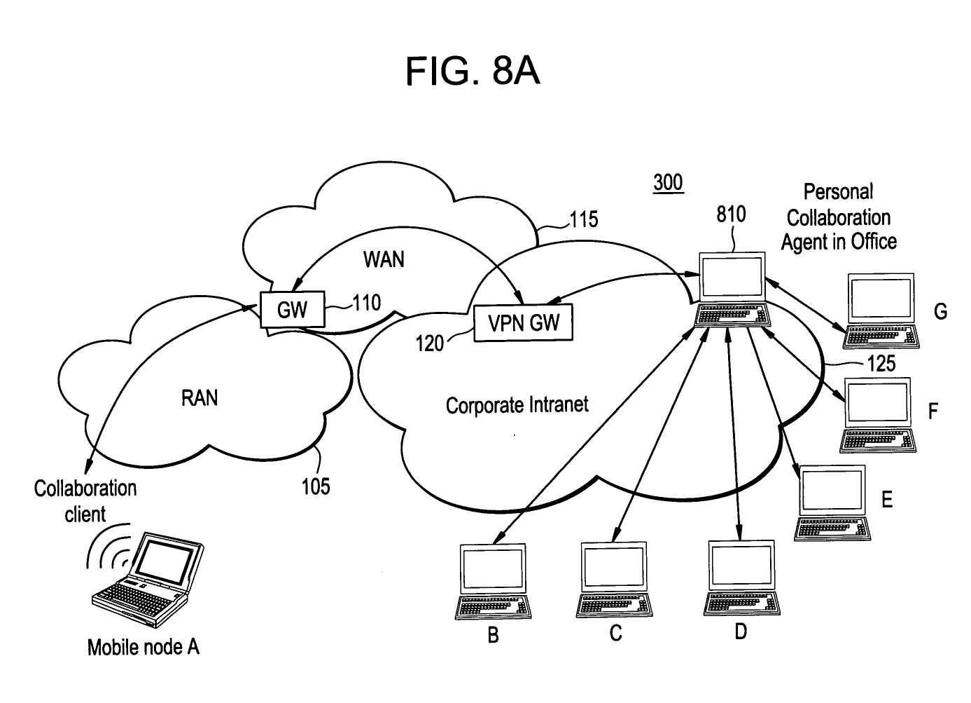

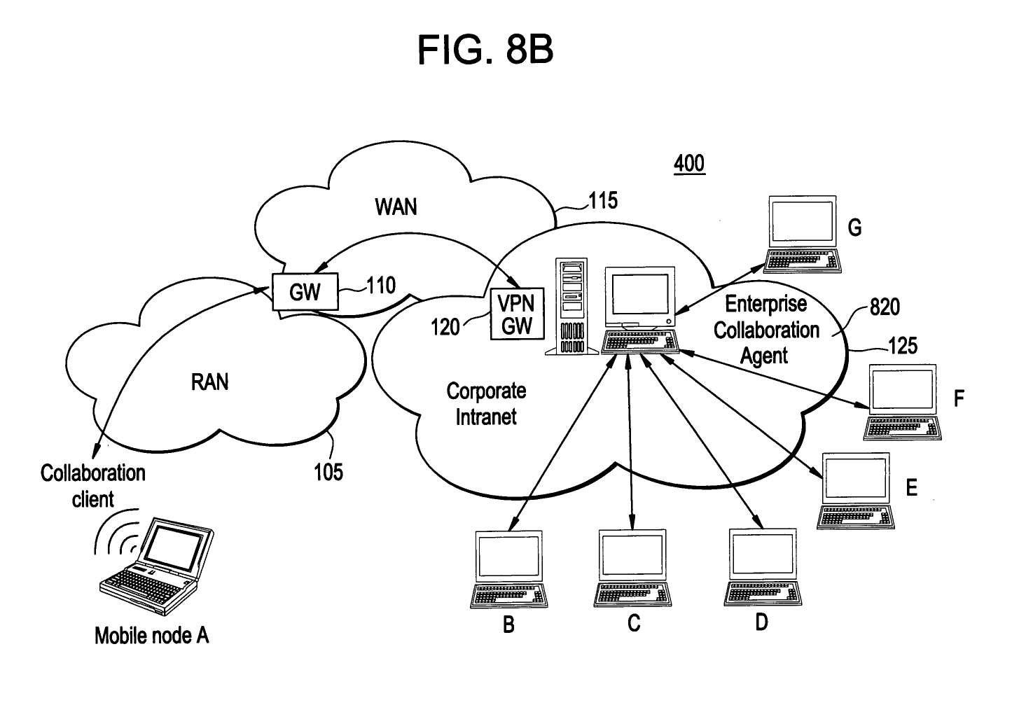

The first through third embodiments of the present invention are described above with reference to network 200 in which the collaboration agent 130 exists within the WAN 115. However, the first through third embodiments can also be applied to networks in which the collaboration agent 130 is not within the WAN 115. For example, the first through third embodiments could be applied to networks 300 and 400 illustrated in FIGS. 8A and 8B, respectively, in which the collaboration agent is not within the WAN 115.

FIG. 8A illustrates network 300 which is identical to the network 200 described with reference to FIG. 2 with the exception that the collaboration agent 130 illustrated as being connected to the WAN 115 in FIG. 2 is replaced with the collaboration agent 810. The collaboration agent 810 is a personal computer or server located in, for example, an office that is connected to the corporate intranet 125 via a link providing substantially higher and more predictable bandwidth than the wireless access link of the node A, such as a wired connection or a wireless ethernet connection. The collaboration agent 810 operates in the same manner as the collaboration agent 130 described above with reference to FIGS. 2-7.

FIG. 8B illustrates network 400 which is identical to the network 200 described with reference to FIG. 2 with the exception that the collaboration agent 130 illustrated as being connected to the WAN 115 in FIG. 2 is replaced with the collaboration agent 820. The collaboration agent 820 is an enterprise collaboration agent which may be embodied as, for example, a server connected to the corporate intranet 125 via a link providing substantially higher and more predictable bandwidth than the wireless access link of the node A, such as a wired connection or a wireless ethernet connection. The collaboration agent 820 operates in the same manner as the collaboration agent 130 described above with reference to FIGS. 2-7.

Embodiments of the invention being thus described, it will be obvious that embodiments may be varied in many ways. Such variations are not to be regarded as a departure from the invention, and all such modifications are intended to be included within the scope of the invention.

What is claimed:

1. A method of sending data from a first node participating in a session of a collaborative application via a wireless access link to a first network to a plurality of second nodes participating in the session of the collaborative application, the method comprising:
generating a plurality of data streams corresponding to the plurality of second nodes at the first node;
performing a compression operation on the plurality of data streams by reducing the plurality of data streams to a single data stream from among the plurality of data streams; and
sending the single data stream to a collaboration agent associated with the first node, the collaboration agent being connected to a second network through a link having at least one of higher reliability and higher bandwidth compared to the wireless access link of the first node.

2. The method of claim 1 wherein the first network is a Radio Access Network (RAN) and the first node is a mobile node in communication with the RAN through the wireless access link.

3. The method of claim 2 wherein the second network includes a wide area network (WAN) connected to the RAN.

4. The method of claim 3 wherein the second network further includes an intranet connected to the WAN, and the second nodes are each connected to the intranet.

5. The method of claim 3 wherein the collaboration agent is connected to the WAN.

6. The method of claim 5 wherein the collaboration agent is connected to the intranet and is at least one of a personal computer and a server.

7. The method of claim 1 wherein the compression operation includes selecting an encoding technique based on the uplink bandwidth available to the first node, and applying the selected encoding technique to the single data stream.

8. A method of forwarding data received from a first node participating in a session of a collaborative application via a wireless access link to a first network to a plurality of other nodes participating in the session of the collaborative application, the method comprising:
receiving a single data stream from the first node at a collaboration agent connected to a second network through a link having at least one of higher reliability and higher bandwidth compared to the wireless access link of the first node;
performing a decompression operation on the single data stream by forming copies of the single data stream corresponding to each of the plurality of second nodes; and
sending the formed copies of the single data stream to each of the plurality of second nodes.

9. The method of claim 8 wherein the first network is a Radio Access Network (RAN) and the first node is a mobile node in wireless communication with the RAN through the wireless access link.

10. The method of claim 9 wherein the second network includes a wide area network (WAN) connected to the RAN.

11. The method of claim 10 wherein the second network further includes an intranet connected to the WAN, and the second nodes are each connected to the intranet.

12. The method of claim 10 wherein the collaboration agent is connected to the WAN.

13. The method of claim 11 wherein the collaboration agent is connected to the intranet and is at least one of a personal computer and a server.

14. A method of handling a first call sent to a first node capable of participating in a session of a collaborative application via a wireless access link to a first network from a second node attempting to join a session of the collaborative application with the first node, the method comprising:
receiving the first call sent from the second node at a collaboration agent associated with the first node, the collaboration agent being connected to a second network through a link having at least one of higher reliability and higher bandwidth compared to the wireless access link of the first node;
connecting an instance of the collaborative application running at the second node to an instance of the collaborative application running at the collaboration agent based on the first call;
placing a second call from the collaboration agent to the first node;
connecting the instance of the collaborative application running at the collaboration agent to an instance of the collaborative application running at the first node based on the second call such that the first node, the second node and the collaboration agent are all participating in the session of the collaborative application.

15. A method of handling a first call sent from a first node attempting to join a session of a collaborative application via a wireless access link to a first network to a second node participating in the session of the collaborative application, the method comprising:
receiving the first call sent from the first node at a collaboration agent associated with the first node, the collaboration agent being connected to a second network through a link having at least one of higher reliability and higher bandwidth compared to the wireless access link of the first node;
placing a second call from the collaboration agent to the second node; and
connecting an instance of the collaborative application running at the second node to an instance of the collaborative application running at the collaboration agent based on the second call.

16. The method of claim 15 further comprising:
accepting the first call received from the first node; and
connecting an instance of the collaborative application running at the first node to the instance of the collaborative application running at the collaboration agent based on the first call such that the first node, the second node and the collaboration agent are all participating in the session of the collaborative application.

17. The method of claim 15 further comprising:
rejecting the first call received from the first node at the collaboration agent;
placing a third call from the collaboration agent to the first node; and
connecting an instance of the collaborative application running at the first node to the instance of the collaborative application running at the collaboration agent based on the third call such that the first node, the second node and the collaboration agent are all participating in the session of the collaborative application.

18. A method of sending data from a first node participating in a session of a collaborative application via a wireless access link to a first network to a plurality of second nodes participating in the session of the collaborative application, the method comprising:
registering the first node with a collaboration agent, the collaboration agent being connected to a second network through a link having at least one of higher reliability and higher bandwidth compared to the wireless access link of the first node;
controlling the collaboration agent to run an instance of the collaborative application, using a collaboration agent control window viewable on a display of the first node, the collaboration control window being connected to a control process running on the collaboration agent via a terminal link;
selecting an icon associated with desired data via the display of the first node;
controlling the collaboration agent to send the desired data to the plurality of second nodes using the collaboration control window.

19. The method of claim 18, wherein the desired data is located at the first node, and the selecting the icon associated with the desired data includes selecting an icon associated with a local drive of the first node, and sending the desired data to the collaboration agent via the terminal link.

20. The method of claim 18, wherein the desired data is located at one of a network drive connected to the second network and the collaboration agent, and the selecting the icon associated with the desired data includes selecting an icon located within the collaboration control window.

21. The method of claim 18 wherein the terminal link is a bi-directional logical connection capable of carrying control signals and multimedia data between the first node and the collaboration agent.

22. The method of claim 21, further comprising:
receiving, after controlling the collaboration agent to run the instance of the collaborative application, data packets representing a screen-view associated with the collaborative application from the collaboration agent at an application proxy process running on the first node, the data packets being received via the terminal link;
extracting the screen-view from the received data packets using the application proxy process;
displaying the extracted screen-view on the display of the first node.

23. A method of forwarding data from a first node participating in a session of a collaborative application via a wireless access link to a first network to a plurality of other nodes participating in the session of the collaborative application, the method comprising:
registering the first node with a collaboration agent, the collaboration agent being connected to a second network through a link having at least one of higher reliability and higher bandwidth compared to the wireless access link of the first node;
running an instance of the collaborative application at the collaboration agent based on first control signals received from the first node by a control process running on the collaboration agent via a terminal link;
receiving, at the control process, second control signals indicating to send desired data via the terminal link;
sending the desired data from the collaboration agent to the plurality of second nodes based on the second control signals.

24. The method of claim 23, wherein the desired data is located at the first node, and the receiving the second control signals includes receiving the desired data from the first node.

25. The method of claim 23, further comprising:
packetizing, after running an instance of the collaborative application, data representing a screen-view associated with the collaborative application using a device driver proxy process running on the collaboration agent;
sending the packetized data from collaboration agent to the first node via the terminal link.
